(19) United States
(12) Patent Application Publication
(10) Pub. No.: US 2013/0038948 A1
(43) Pub. Date: Feb. 14, 2013

(54) LENS DEVICE AND ELECTRONIC APPARATUS

(71) Applicant: Hisateru Okai, Osaka (JP)

(72) Inventor: Hisateru Okai, Osaka (JP)

(73) Assignee: SHARP KABUSHIKI KAISHA, Osaka (JP)

(21) Appl. No.: 13/569,320

(22) Filed: Aug. 8, 2012

(30) Foreign Application Priority Data
Aug. 9, 2011 (JP) 2011-174311

(51) Int. Cl. G02B 7/02

(52) U.S. Cl. 359/738

(57) ABSTRACT

In an image pickup element module, a light blocking plate sandwiched between a first lens and a second lens is provided with fixing holes. The light blocking plate is retained by the second lens by projections from the second lens being inserted into the fixing holes. This prevents the light blocking plate from being displaced due to vibration or impact, thus making it possible to keep the optical characteristics of the image pickup element module satisfactory and provide the image pickup element module inexpensively.

This Nonprovisional application claims priority under 35 U.S.C. §119(a) on Patent Application No. 2011-174311 filed in Japan on Aug. 9, 2011, the entire contents of which are hereby incorporated by reference.

### TECHNICAL FIELD

The present invention relates to (i) a lens device having an individual laminate lens cut out from a lens wafer laminate obtained by laminating a plurality of lens wafers each formed from a plurality of lenses and (ii) an electronic apparatus in which such a lens device is used.

### BACKGROUND ART

In recent years, there has been an ongoing reduction in the prices of camera modules that are mounted in cellular phones and the like. Under such circumstances, there has been a growing need for more inexpensive camera modules. Further, since most components for use in cellular phones are reflow-mounted, camera modules are required to be reflow-mountable, too.

Various improvements have been made in order to reduce the cost of fabricating camera modules. For example, Patent Literature 1 discloses a method for batch-fabricating a plurality of lens units to be incorporated into camera modules. According to this method, a laminate lens is obtained in the form of a lens unit by cutting out each individual lens from a lens wafer laminate obtained by laminating lens wafers each having a plurality of lenses.

Further, in order to inexpensively fabricate lens units that can withstand reflow mounting, use of lenses made of resin, not glass, has already been in practice. However, lenses made of resin thermally expand due to heat treatment during reflow mounting. For this reason, in the case of a structure in which the inner side of a body tube in which lenses are placed and lens side surfaces are in contact, the body tube is pushed wide by the lenses thermally expanding. This may cause a deformation in or destruction of the body tube, or may displace an optical axis between the lenses. In order to prevent such a problem attributed to thermal expansion of the lenses, a clearance is provided between the lens side surfaces and the body tube. Patent Literature 1 discloses such a structure.

FIG. 13 is a longitudinal sectional view showing a configuration of an image pickup element module (electronic element module) described in Patent Literature 1. FIG. 14(a) is a longitudinal sectional view showing a structure of a first lens in the image pickup module, and FIG. 14(b) is a longitudinal sectional view showing a structure of a second lens in the image pickup module.

As shown in FIG. 13, the image pickup element module 400, serving as a camera module, includes a light blocking holder 401, an image pickup element unit 402, a first lens 403, a second lens 404, and a light blocking plate 405.

The first lens 403 and the second lens 404 are placed in the light blocking holder 401. The image pickup element unit 402 is attached to the light blocking holder 401 so as to receive light having traveled through the first lens 403 and the second lens 404.

As shown in FIG. 14(a), the first lens 403 has a spacer section 403a facing the second lens 404 and having a flat surface raised in the form of a ring. As shown in FIG. 14(b), the second lens 404 has a spacer section 404a facing the first lens 403 and having a flat surface raised in the form of a ring.

By being sandwiched between the spacer section 403a of the first lens 403 and the spacer section 404a of the second lens 404, the light blocking plate 405 is retained between the first lens 403 and the second lens 404, as shown in FIG. 13. The first lens 403 and the second lens 404 are bonded to each other with an adhesive at their peripheral edges. The first lens 403, the second lens 404, the light blocking plate 405, and the adhesive 406 constitute a lens unit 407.

The first lens 403 is obtained from a lens wafer formed from plural patterns of first lenses 403. The second lens 404 is obtained from a lens wafer formed from plural patterns of first lenses 404. The light blocking plate 405 is obtained from a light blocking plate wafer formed from plural patterns of light blocking plates 405. The lens unit 407 is cut out as an individual lens unit by dicing the two lens wafers bonded to each other with the light blocking plate wafer sandwiched therebetween.

Provided between the inner wall of the light blocking holder 401, which corresponds to a tube body, and the side surface of the lens unit 7 is a clearance d, which prevents the lens unit 7 from being fixed to the side wall part of the light blocking holder 401.

Therefore, as shown in FIG. 13, the light blocking plate 405 is retained simply by being sandwiched between the first lens 403 and the second lens 404.

### CITATION LIST

Patent Literature 1
Japanese Patent Application Publication, Tokukai, No. 2011-48304 A (Publication Date: Mar. 10, 2011)

### SUMMARY OF INVENTION

### Technical Problem

However, in the structure in which the light blocking plate 405 is simply sandwiched between the first lens 403 and the second lens 404, the light blocking plate 405 is easily displaced due to vibration or impact. This gives rise to such a problem that the light blocking plate 405 cannot fully exert its functions, with the result that there is deterioration in optical characteristics.

Accordingly, by fixing the light blocking plate 405 with the adhesive 406, the light blocking plate 405 can be retained in such a manner as not to be displaced. However, to fix the light blocking plate 405 together with the first lens 403 and the second lens 404 with the adhesive 406, a sufficient amount of the adhesive 406 to fix the light blocking plate 405 is required. This requires an addition to the amount of the adhesive 406 required to bond the first and second lenses 403 and 404 to each other. Therefore, there is such a problem that the fabricating cost piles up by just that much.

### Solution to Problem

It is an object of the present invention to provide a lens device with satisfactory optical characteristics while minimizing an increase in the fabricating cost and at the same time preventing the light blocking plate and the lenses from being displaced with respect to each other.

A lens device according to the present invention is a lens device including: a lens unit having two or more lenses made of resin and bonded to each other and a light blocking plate placed between each of the lenses and the other; and a body tube in which the lens unit is placed, with a clearance provided between the lens unit and the body tube, at least one of the lenses having at least two projections, the light blocking plate having a retention structure for retaining the projections.

In the foregoing configuration, the projections from the lens(es) are retained by the retention structure of the light blocking plate. This allows the light blocking plate to follow the movement of the lenses even when the lens unit is subjected to vibration or impact. Therefore, the light blocking plate is can be prevented from being displaced with respect to the lenses. This prevents the optical characteristics of the lens device from being impaired. Further, the use of an adhesive to fix the light blocking plate to the lenses is eliminated. This makes it possible to curb the cost of fabricating the lens device.

An electronic apparatus according to the present invention is mounted with such a lens device including an image pickup element unit.

By being mounted with the lens device, the electronic apparatus can be configured with high performance at a low price.

### Advantageous Effects of Invention

By being thus configured, the lens device according to the present invention can minimize an increase in the fabricating cost and at the same time prevent the light blocking plate from being displaced due to vibration or impact. This brings about an effect of making it possible to obtain an inexpensive lens device having satisfactory optical characteristics.

### BRIEF DESCRIPTION OF DRAWINGS

FIG. 1 is a cross-sectional view showing a structure of an image pickup element module according to an embodiment of the present invention.

FIG. 2(a) is a plan view showing a structure of a light blocking plate wafer formed from plural patterns of light blocking plates each of which is used in a lens unit in the image pickup element module.

FIG. 2(b) is a plan view showing a structure of another light blocking plate wafer.

FIG. 3(a) is a plan view showing a structure of a type of light blocking plate in the image pickup element module.

FIG. 3(b) is a plan view showing a structure of another type of light blocking plate in the image pickup element module.

FIG. 3(c) is a plan view showing a structure of another type of light blocking plate in the image pickup element module.

FIG. 3(d) is a plan view showing a structure of another type of light blocking plate in the image pickup element module.

FIG. 4(a) is a longitudinal sectional view showing a structure of a first lens constituting the lens unit.

FIG. 4(b) is a longitudinal sectional view showing a structure of a second lens constituting the lens unit.

FIG. 5(a) is a plan view showing a structure of a second lens.

FIG. 5(b) is a cross-sectional view taken along the line A-A of FIG. 5(a).

FIG. 6(a) is a plan view showing a structure of another second lens.

FIG. 6(b) is a cross-sectional view taken along the line B-B of FIG. 6(a).

FIG. 7(a) is a plan view showing a structure of still another second lens.

FIG. 7(b) is a cross-sectional view taken along the line C-C of FIG. 7(a).

FIG. 8(a) is a set of cross-sectional views showing an adhesive application step in fabrication of the lens unit.

FIG. 8(b) is a set of cross-sectional views showing a bonding step in fabrication of the lens unit.

FIG. 8(c) is a set of cross-sectional views showing a cutting step in fabrication of the lens unit.

FIG. 9(a) is a cross-sectional view showing a configuration of a lens unit according to a modification of the present embodiment.

FIG. 9(b) is a cross-sectional view showing a configuration of another lens unit according to the modification of the present embodiment.

FIG. 10 is a cross-sectional view showing a structure of a lens unit that is used in an image pickup element module according to another embodiment of the present invention.

FIG. 11(a) is a cross-sectional view showing a structure of a lens unit that is used in the image pickup element module of FIG. 10.

FIG. 11(b) is a cross-sectional view showing a structure of another lens unit that is used in the image pickup element module of FIG. 10.

FIG. 11(c) is a cross-sectional view showing a structure of still another lens unit that is used in the image pickup element module of FIG. 10.

FIG. 12 is a block diagram schematically showing a configuration of an electronic apparatus according still another embodiment of the present invention.

FIG. 13 is a longitudinal sectional view showing a configuration of a conventional image pickup element module.

FIG. 14(a) is a longitudinal sectional view showing a structure of a first lens in the image pickup element module of FIG. 13.

FIG. 14(b) is a longitudinal sectional view showing a structure of a second lens in the image pickup element module of FIG. 13.

### DESCRIPTION OF EMBODIMENTS

### Embodiment 1

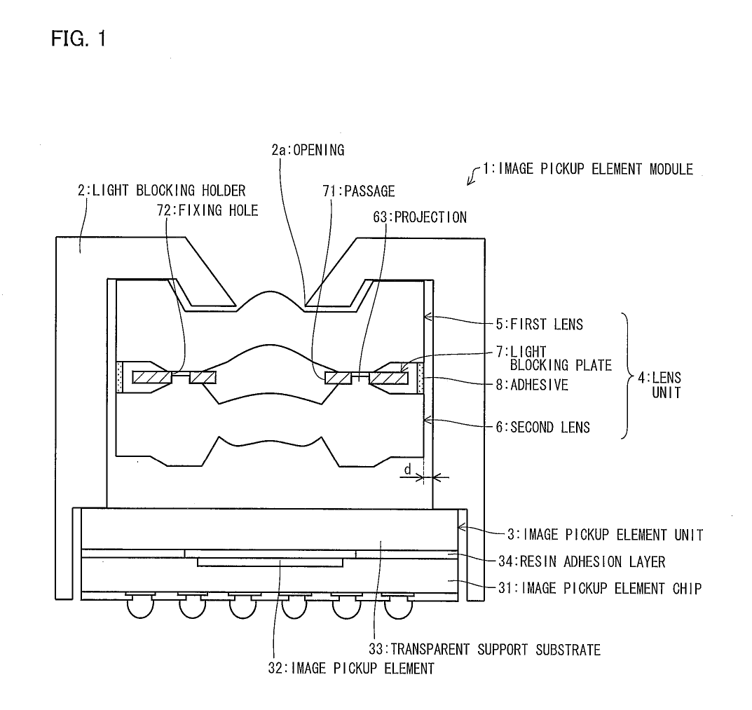

An embodiment of the present invention is described below with reference to FIGS. 1 through 9(b).

(Configuration of an Image Pickup Element Module)

FIG. 1 is a longitudinal sectional view showing in detail a configuration of an image pickup element module 1 according to the present embodiment.

As shown in FIG. 1, the image pickup element module 1 (lens device) according to the present embodiment includes a light blocking holder 2, an image pickup element unit 3, and a lens unit 4.

The light blocking holder 2 (body tube) is a casing in which the lens unit 4 and the image pickup element unit 3 are placed. The light blocking holder 2 is made of a light blocking resin so as to block outside light from entering the inside.

The lens unit 4, placed within the light blocking holder 2, guides light having entered through an opening 2a in the light blocking holder 2 toward the inside. The image pickup element unit 3, attached to an end of the light blocking holder 2 opposite the opening 2a, is placed in a such a position as to receive light having traveled through the lens unit 4. Provided between the lens unit 4 and the inner wall surface of the light blocking holder 2 is a space serving as a clearance d.

(Configuration of the Image Pickup Element Unit)

The image pickup element unit 3 has an image pickup element chip 31, an image pickup element 32, a transparent support substrate 33, and a resin adhesion layer 34.

The image pickup element 32 has a plurality of light-receiving sections which take an image of a subject, and is placed in the central part of the image pickup element chip 31. The transparent support substrate 33 is joined to the image pickup element chip 31 with the resin adhesion layer 34 formed in the area around the image pickup element 32.

(Configuration of the Lens Unit)

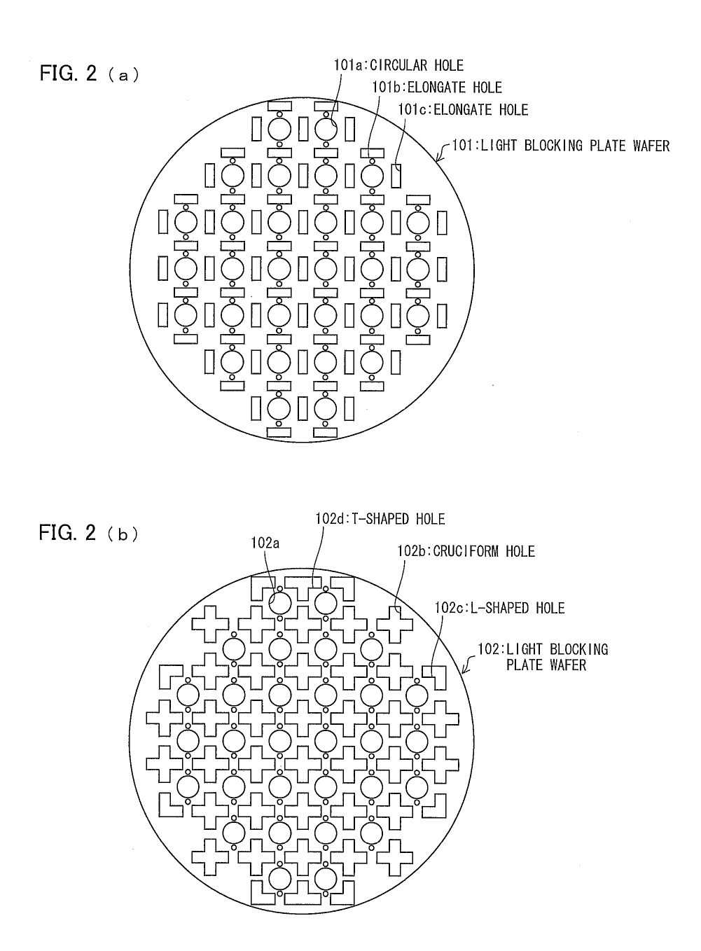

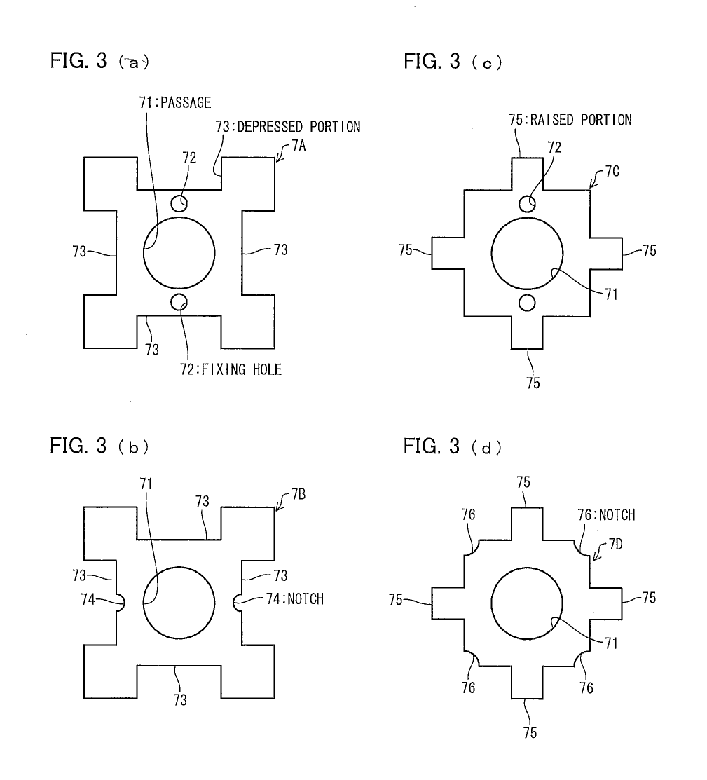

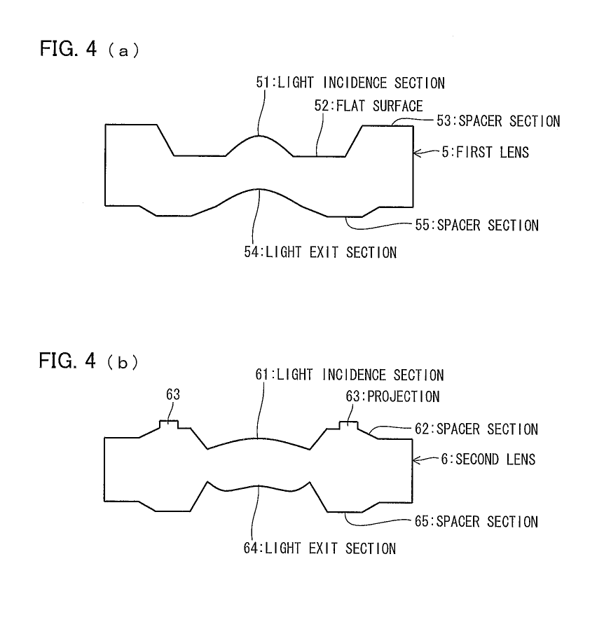

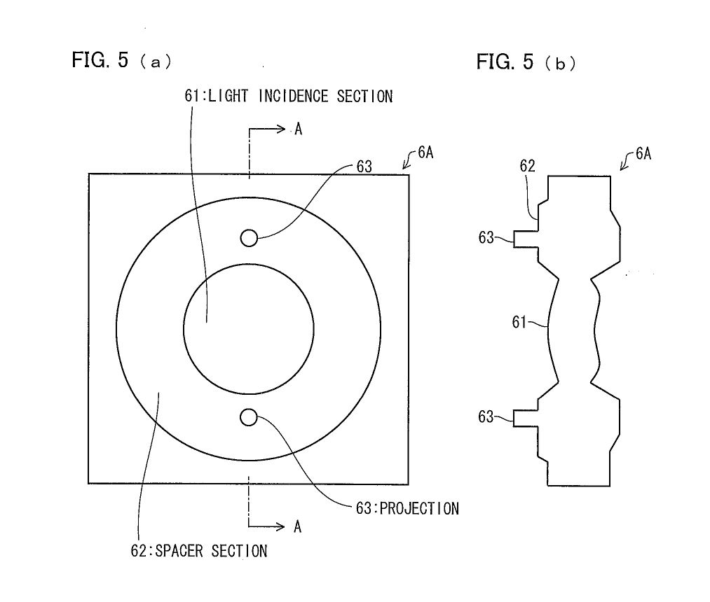

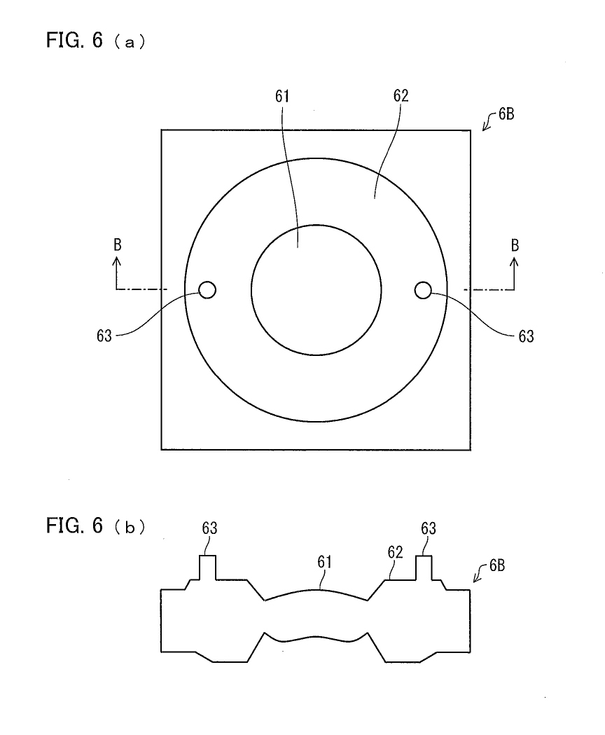

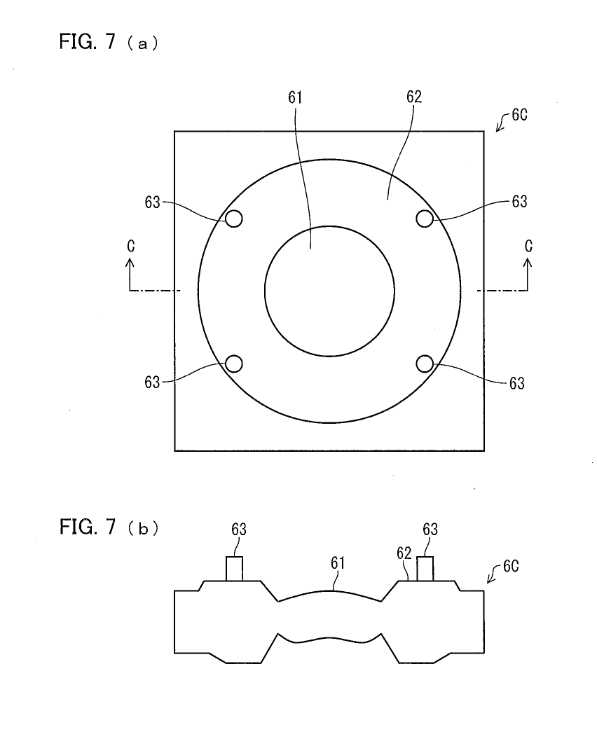

FIGS. 2(a) and 2(b) are plan views showing structures of light blocking plate wafers 101 and 102, respectively, each formed from plural patterns of light blocking plates 7. FIGS. 3(a) to 3(d) are plan views showing structures of light blocking plates 7 (7A to 7D), respectively, each constituting the lens unit 4. FIG. 4(a) is a longitudinal sectional view showing a structure of a first lens 5 constituting the lens unit 4, and FIG. 4(b) is a longitudinal sectional view showing a structure of a second lens 6 constituting the lens unit 4. FIG. 5(a) is a plan view showing a structure of a second lens 6, and FIG. 5(b) is a cross-sectional view taken along the line A-A of FIG. 5(a). FIG. 6(a) is a plan view showing a structure of another second lens 6, and FIG. 6(b) is a cross-sectional view taken along the line B-B of FIG. 6(a). FIG. 7(a) is a plan view showing a structure of still another second lens 6, and FIG. 7(b) is a cross-sectional view taken along the line C-C of FIG. 7(a).

As shown in FIG. 1, the lens unit 4 is constituted by a first lens 5, a second lens 6, a light blocking plate 7, and an adhesive 8. The light blocking plate 7 is sandwiched between the first lens 5 and the second lens 6, and is retained by projections 63 from the second lens 6. The projections 63 will be described later.

Further, the clearance d is provided between the lens unit 4 and the light blocking holder 2 so as to prevent the lens unit 4 constituted by the first lens 5, the second lens 6, and the light blocking plate 7, each of which is made of resin, from making contact with the light blocking holder 2 even when the lens unit 4 thermally expands during reflow mounting of the image pickup element module 1. This prevents the light blocking holder 2 from being pushed wide by the lens unit 4 thermally expanding, thus making it possible to avoid a deformation in or destruction of the light blocking holder 2. It should be noted that such a clearance d is provided between each of the after-mentioned lens units 4A, 4B, 22, and 22A to 22C and the light blocking holder 2.

The light blocking plate 7 is provided so that light (stray light) other than light entering the aforementioned image pickup element 32 is blocked from entering the second lens 6 through the first lens 5. Further, the light blocking plate 7 has a circular passage 71 through which light passes to enter the image pickup element 32.

The light blocking plate 7 is retained by the first lens 5 and the second lens 6 by being sandwiched between the first lens 5 and the second lens 6. Further, the light blocking plate 7 is retained by the second lens 6 by the projections 63 provided on the second lens 6 being inserted into fixing holes 72 provided in the light blocking plate 7 or being fitted in notches (not illustrated).

In this state, a clearance is formed between the tip of each projection 63 and the first lens 5. This prevents the projections 63 from making contact with the first lens 5 even when the projections 63 become larger due to such thermal expansion as that described above. This makes it possible to avoid such inconvenience that the projections 63 knock up the first lens 5 due to thermal expansion.

The fixing holes 72 and the notches will be described in detail later.

The first lens 5 and the second lens 6 are joined together by being bonded to each other with the adhesive 8 at their peripheral edge surfaces facing each other.

<Configuration of a Light Blocking Plate Wafer>

The light blocking plate 7 is obtained by cutting out an individual light blocking plate from the light blocking plate wafer 101 shown in FIG. 2(a) or from the light blocking plate wafer 102 shown in FIG. 2(b).

As shown in FIG. 2(a), the light blocking plate wafer 101, made of a light blocking resin in the form of a disk, has a plurality of circular holes 101a and a plurality of elongate holes 101b and 101c. The circular holes 101a, each of which is to form the aforementioned passage 71, are arranged in a matrix in the drawing. The elongate holes 101b, which are cutoff guide holes each formed in the shape of a rectangle, are formed so that their longer sides extend in a transverse direction in the drawing. The elongate holes 101c, which are cutoff guide holes each formed in the shape of a rectangle, are formed so that their longer sides extend in a longitudinal direction in the drawing.

The light blocking plate 7 is cut out from the light blocking plate wafer 101 thus configured. The light blocking plate 7 is cut out by cutting the light blocking plate wafer 101 along dicing lines each passing through elongated holes 101b arranged in a straight line and along dicing lines each passing through elongated holes 101c arranged in a straight line.

Meanwhile, as shown in FIG. 2(b), the light blocking plate wafer 102, made of a light blocking resin in the form of a disk, has a plurality of circular holes 102a, a plurality of cruciform holes 102b, a plurality of L-shaped holes 102c, and a plurality of T-shaped holes 102d. The circular holes 102a, each of which is to form the aforementioned passage 71, are arranged in a matrix in the drawing. The cruciform holes 102b, which are cutoff guide holes each formed in the shape of a cross, are arranged in a matrix in the drawing. The L-shaped holes 102c, which are cutoff guide holes each formed in the shape of the letter L, are placed near some circular holes 102a placed on the peripheral side of the light blocking plate wafer 102. The T-shaped holes 102d, which are cutoff guide holes each formed in the shape of the letter T, are placed near some circular holes 102a placed on the peripheral side of the light blocking plate wafer 102.

For the light blocking plate 7 to be cut out from the light blocking plate wafer 102 thus configured, the light blocking plate wafer 102 is cut by dicing along dicing lines. The dicing lines are lines each passing through cruciform holes 102b arranged in a straight line, lines each passing through cruciform holes 102b and L-shaped holes 102c arranged in a straight line, and a line passing through cruciform holes 102b and T-shaped holes 102d arranged in a straight line.

<Configuration of the Light Blocking Plate>

FIG. 3(a) shows a light blocking plate 7A as the light blocking plate 7. The light blocking plate 7A has a passage in the central part thereof, and has fixing holes 72 (insertion hole) around the passage 71. The fixing holes 72 are holes into which the projections 63 from the second lens 6 are inserted, and are formed in correspondence with the positions of the projections 63. Further, the number of fixing holes 72 provided is two, not one, so that the light blocking plate 7 does not rotate on a single projection 63.

Further, the light blocking plate 7A has depressed portions 73 in the four side surfaces. Each of these depressed portions 73 is a half portion of an elongate hole 101b or 101c as formed by the light blocking plate 7A being cut out from the light blocking plate wafer 101 along the dicing lines.

FIG. 3(b) shows a light blocking plate 7B as the light blocking plate 7. As with the light blocking plate 7A, the light blocking plate 7B has a passage 71 in the central part thereof, and has depressed portions in side surfaces thereof. Instead of having the fixing holes 72, the light blocking plate 7B has notches 74. The notches 74 are depressed portions in which the projections 63 from the second lens 6 are fitted, and are formed in the shape of semicircles in correspondence with the positions of the projections 63. Further, the notches 74 are formed in positions opposite the end daces of the depressed portions 73 that face the passage 71, so that the light blocking plate 7B is held between the projections 63 on both sides.

FIG. 3(c) shows a light blocking plate 7C as the light blocking plate 7. As with the light blocking plate 7A, the light blocking plate 7C has a passage 71 in the central part thereof, and has fixing holes 72 (insertion hole) around the passage 71. Further, the light blocking plate 7C has raised portions 75 on the four side surfaces. Each of these raised portions 75 is a portion corresponding to each hole 102b to 102d formed by the light blocking plate 7C being cut out from the light blocking plate wafer 102 along the dicing lines.

FIG. 3(d) shows a light blocking plate 7D as the light blocking plate 7. As with the light blocking plate 7C, the light blocking plate 7D has a passage 71 in the central part thereof, and has raised portions 75 on the side surfaces. Instead of having the fixing holes 72, the light blocking plate 7D has four notches 76. The notches 76 are depressed portions in which the projections from the second lens 6 are fitted, and are each formed in the shape of a quadrant in the corner between adjacent depressed portions 75, in such a manner as to correspond to the positions of the projections 63.

<Configuration of the First Lens>

As shown in FIG. 4(a), the first lens 5 (lens) has a light incidence section 51, a flat surface 52, a spacer section 53, a light exit section 54, and a spacer section 55. Although not illustrated, the first lens 5 has a square contour and is made of a transparent resin material.

The light incidence section 51, provided in the central part of the light incidence side of the first lens 5, has a convex optical surface on which light is incident. The flat surface 52 is formed in the shape of a circular ring in a position around the light incidence section 51 that is lower than the light incidence section 51. The spacer section 53, provided in the area around the flat surface 52, has a flat surface formed in a higher position than the light incidence section 51. The first lens 5 is joined with an adhesive between the flat surface of the spacer section 53 and the inner wall surface of the light blocking holder 2 near the opening 2a.

The light exit section 54, provided in the central part of the light exit side of the first lens 5, has a concave optical surface. The spacer section 55 is formed in the shape of a circular ring in a position around the light exit section 54 that is higher than the light exit section 54.

<Configuration of the Second Lens>

As shown in FIG. 4(b), the first lens 6 (lens) has a light incidence section 61, a spacer section 62, projections 63, a light exit section 64, and a spacer section 65. Although not illustrated, the second lens 6 has a square contour and is made of a transparent resin material.

The light incidence section 61, provided in the central part of the light incidence side of the second lens 6, has a convex optical surface on which light is incident. The spacer section 62, formed in the shape of a circular ring in a position around the light incidence section 61 that is higher than the light incidence section 61, has a flat surface at the top. The projections 63, provided on the flat surface of the spacer section 62, are formed in the shape of cylinders in such a manner as to project toward the spacer section 55 of the first lens 5.

The projections 63 are not limited in shape to cylinders. The projections 63 may be formed in any one of the various shapes of prisms, cones, truncated cones, walls, etc. The same applied to the after-mentioned projections 56, 57, 66, and 222.

Further provided between each of the projections 63 and each of the fixing holes 72 or the notches 74 or 76 is a clearance that serves to prevent the projections 63 from pushing the fixing holes 72 or the notches 74 or 76 wide when the first lens 5 thermally expands during reflow mounting as mentioned above and thereby causing a deformation in or destruction of the light blocking plate 7. Further, such a clearance is also necessary for the fixing holes 72 or the notches 74 or 76 to be easily aligned with the projections 63 during assembly of the lens unit 4. Such a clearance is also provided between each of the after-mentioned projections 56, 57, 66, and 222 and each of the fixing holes or notches corresponding thereto.

The light exit section 64, provided in the central part of the light exit side of the second lens 6, has a concave optical surface. The spacer section 65 is formed in the shape of a circular ring in a position around the light exit section 64 that is higher than the light exit section 64.

The positions of the projections 63 provided on the second lens 6 correspond to the positions of the fixing holes 72 or the notches 74 or 76 provided in the light blocking plate 7.

For example, as shown in FIGS. 5(a) and 5(b), a second lens 6A as the second lens 6 has two projections 63, disposed in opposed positions with the light incidence section 61 therebetween on a line passing through the center of the light incidence section 61, which correspond to the aforementioned light blocking plate 7A or 7C. Further, each of the projections 63 is placed in substantially the center of the width of the spacer section 62.

Alternatively, as shown in FIGS. 6(a) and 6(b), a second lens 6B as the second lens 6 has two projections 63, disposed in opposed positions with the light incidence section 61 therebetween on a line passing through the center of the light incidence section 61, which correspond to the aforementioned light blocking plate 7B. Further, each of the projections 63 is placed in a position on the spacer section 62 that is close to the peripheral side of the spacer section 62.

Alternatively, as shown in FIGS. 7(a) and 7(b), a second lens 6C as the second lens 6 has four projections 63, placed at a distance each other in such a manner as to be positioned at the vertices of a square in positions close to the peripheral side of the spacer section 62, which correspond to the aforementioned light blocking plate 7D.

(Fabrication of the Lens Unit)

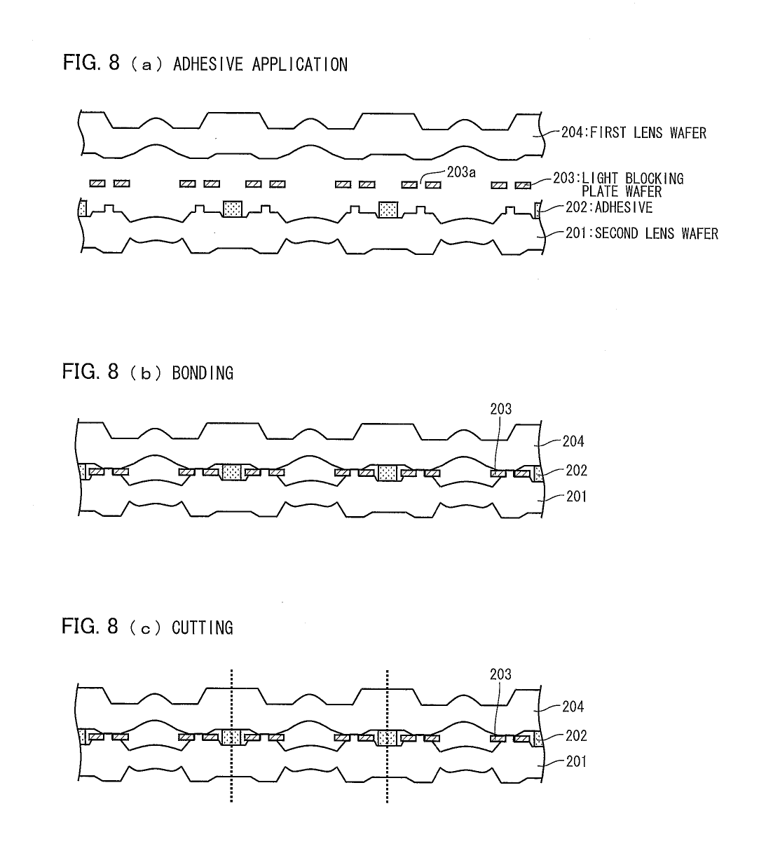

FIGS. 8(a) to 8(c) are cross-sectional views showing steps of fabricating the lens unit 4.

The lens unit 4 is fabricated by executing an adhesive application step (FIG. 8(a)), a bonding step (FIG. 8(b)), and a cutting step (FIG. 8(c)) in this order.

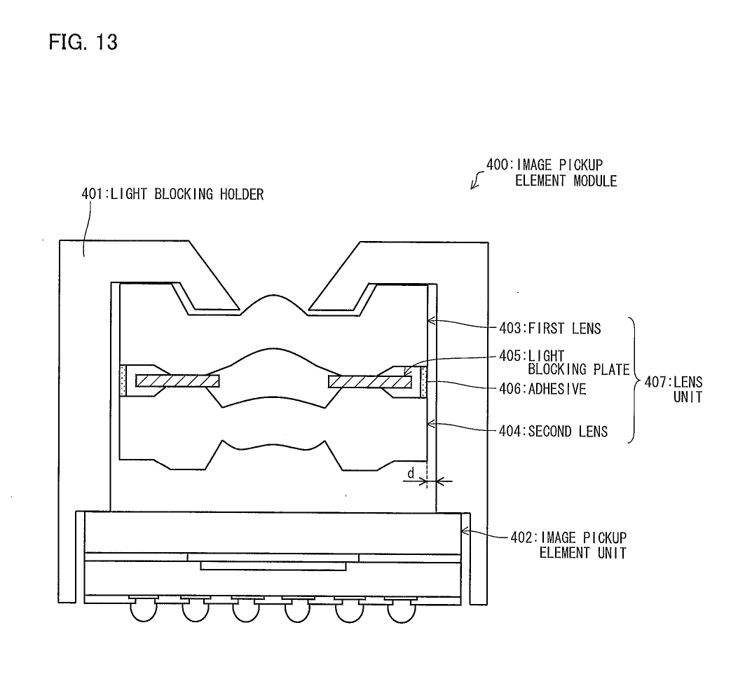

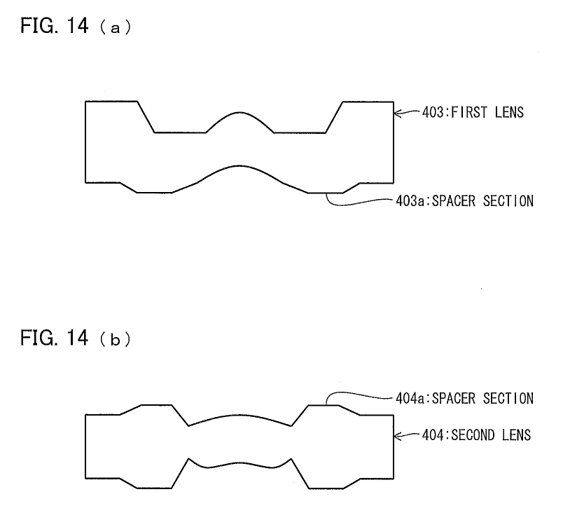

First, in the adhesive application step shown in FIG. 8(a), an adhesive 202 is applied to the adhesion site (region extending along cutoff lines) of a second lens wafer 201 through a nozzle of a dispensing apparatus. In so doing, the adhesive 202 needs only be applied in an amount sufficient to join the second lens wafer 201 to a first lens wafer 204. Therefore, the amount of the adhesive 202 can be made smaller than the amount of an adhesive that is used in fixing the light blocking plate 405 in the conventional image pickup element module 400 shown in FIG. 13.

In the bonding step shown in FIG. 8(b), the projections 63 provided on the second lens wafer 201 are inserted into holes 203a, formed in a light blocking plate wafer 203, which are to serve as fixing holes (or fitted in the notches 74 or 76). This causes the light blocking plate wafer 203 to be placed on the second lens wafer 201. In this state, by placing the first lens wafer 204 on the second lens wafer 201 in alignment with a predetermined position and pressing the first lens wafer 204, the lens wafer 204 is bonded to the second lens wafer 201. The alignment of the first lens wafer 204 on the second lens wafer 201 is the alignment of the optical axes of the lenses. This is how a lens wafer laminate is formed.

In the cutting step shown in (c) of FIG. 8, the lens wafer laminate obtained in the bonding step is cut along dicing lines, whereby the lens unit 4 (laminate lens) is cut out as an individual lens unit.

(Modification)

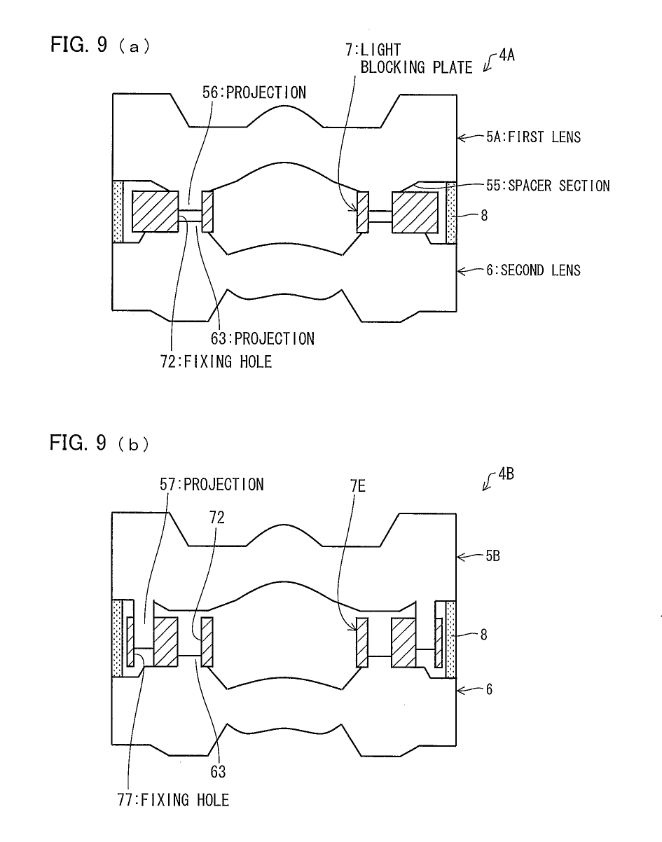

A modification of the present embodiment is described with reference to FIGS. 9(a) and 9(b). FIG. 9(a) is a cross-sectional view showing a configuration of a lens unit 4A according to the present modification, and FIG. 9(b) is a cross-sectional view showing a configuration of another lens unit 4B according to the present modification.

Since the aforementioned lens unit 4 has the projections 63 provided on the second lens 4, those components other than these components are described.

As shown in FIG. 9(a), the lens unit 4A has a first lens 5A and a second lens 6. The first lens 5A has two projections 56 formed in the shape of cylinders on the spacer section 55 in such a manner as to project toward the projections 63. Further, the projections 56 and 63 are of such a length that their tips do not touch each other with the projections 56 and 53 both inserted into the fixing holes 72 and with the light blocking plate 7 sandwiched between the first lens 5A and the second lens 6.

The lens unit 4A is applied to a configuration in which the light blocking plate 7 has the fixing holes 72, but can of course be also applied to a configuration in which the light blocking plate 7 has the aforementioned notches 74 or notches 76.

As shown in FIG. 9(b), the lens unit 4B has a first lens 5B, a second lens 6, and a light blocking plate 7E. The first lens 5B has two projections 57 formed in the shape of cylinders on the peripheral end face of the spacer section 55 in such a manner as to protrude toward the second lens 6. Further, in addition to the fixing holes 72, the light blocking plate 7E has two fixing holes 77 into which the projections 57 are inserted. The fixing holes 77 are formed in two positions different from those of the fixing holes 72 in the light blocking plate 7E. The positions in which the fixing holes 77 are formed is not particularly limited, but may be positions away from those of the fixing holes 72.

Further, the projections 57 are of such a length that their tips do not touch the second lens 6 with the projections 57 inserted into the fixing holes 77 and with the light blocking plate 7E sandwiched between the first lens 5B and the second lens 6.

The lens unit 4B is applied to a configuration in which the light blocking plate 7E has the fixing holes 72 and 77, but can of course be also applied to a configuration in which the light blocking plate 7E has notches equivalent to the aforementioned notches 74 or 76 in correspondence with the fixing holes 72 and 77. Since the light blocking plate 7D shown in FIG. 3(d) has four notches 76, the two projections 63 may be fitted in two of the notches 76, with the other two projections 57 being fitted in the other two notches 76.

In the lens unit 4A, as described above, the light blocking plate 7 is retained by the projections 56 from the first lens 5A and the projections 63 from the second lens 6. Further, in the lens unit 4B, the light blocking plate 7E is retained by the projections 57 from the first lens 5B and the projections 63 from the second lens 6. The stress that retains the light blocking plate 7 is dispersed across the projections 56 and 63 or the projections 57 and 63, the burden on the projections 56, 57, and 63 is reduced. This makes the projections 56, 57, and 63 hard to break.

### General Overview of the Embodiment

As described above, in an image pickup element module 1 according to the present embodiment, a light blocking plate 7 is retained by a second lens 6 by projections 63 being inserted into fixing holes 72 or by the projections 63 from the second lens 6 being fitted in notches 74 or 76. Similarly, the light blocking plate 7 is retained by a first lens 5A or 5B by projections 56 or 57 from the first lens 5A or 5B being inserted into fixing holes 72 or 77 or being fitted in notches 74 or 76, etc.

This allows the light blocking plate 7 to follow the movement of the first lens 5 and the second lens 6 even when the lens unit 4 is subjected to vibration or impact. This makes it possible to prevent the light blocking plate 7 from being displaced with respect to the first lens 5 and the second lens 6 due to vibration or impact. Therefore, the optical characteristics of the image pickup element module 1 including the lens unit 4 can be kept satisfactory. Further, since it is not necessary to fix the light blocking plate 7 with the adhesive 8, the adhesive 8 needs only be used in such a minimum amount as to bond the first lens 5 and the second lens 6 together. This makes it possible to suppress an increase in the cost of fabricating the lens unit 4. Accordingly, the image pickup element module 1 can be provided with high performance at a low price.

Further, since the second lens 6 has the projections 63, it is necessary to use a dedicated die to fabricate a lens wafer for forming the second lens 6, unlike in the case of a conventional lens wafer. On the other hand, since the first lens 5 does not have any projections, a lens wafer for forming the first lens 5 can be fabricated by using the same die as in the case of a conventional lens wafer, unlike in the case of the lens wafer for the second lens 6.

The present embodiment adopts a structure in which the projections 63 are inserted into the fixing holes 72 or fitted in the notches 74 or 76. However, the present embodiment is not limited to such a structure, but the light blocking plate 7 needs only have a retention structure for retaining the projections 63. The projections 63 and the notches 74 or 76 are preferred as a retention structure because the fixing holes 72 can be easily formed in the light blocking plate 7.

### Embodiment 2

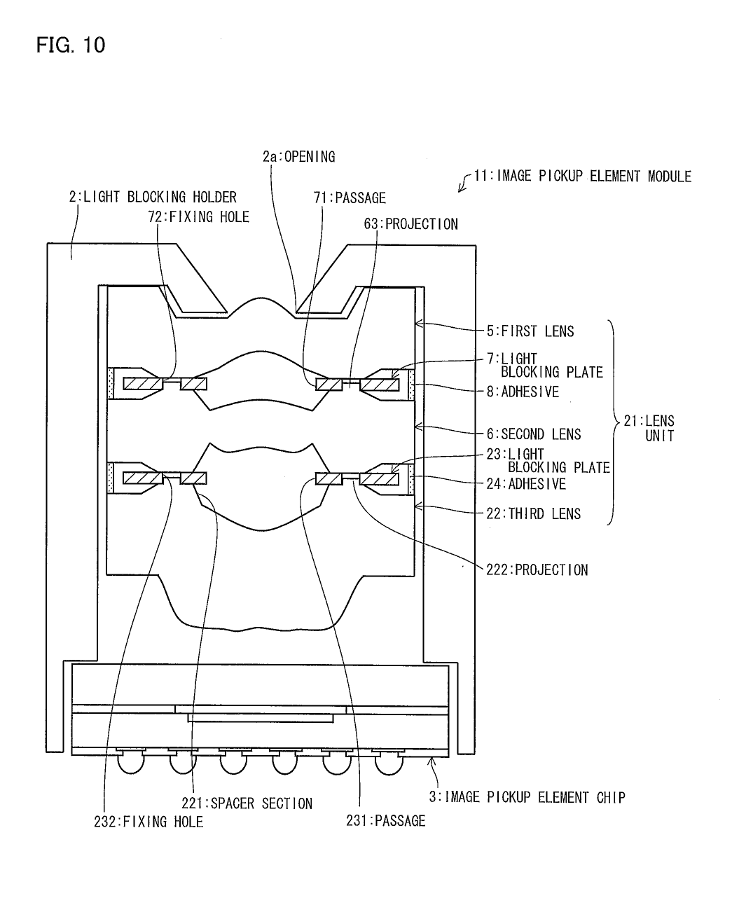

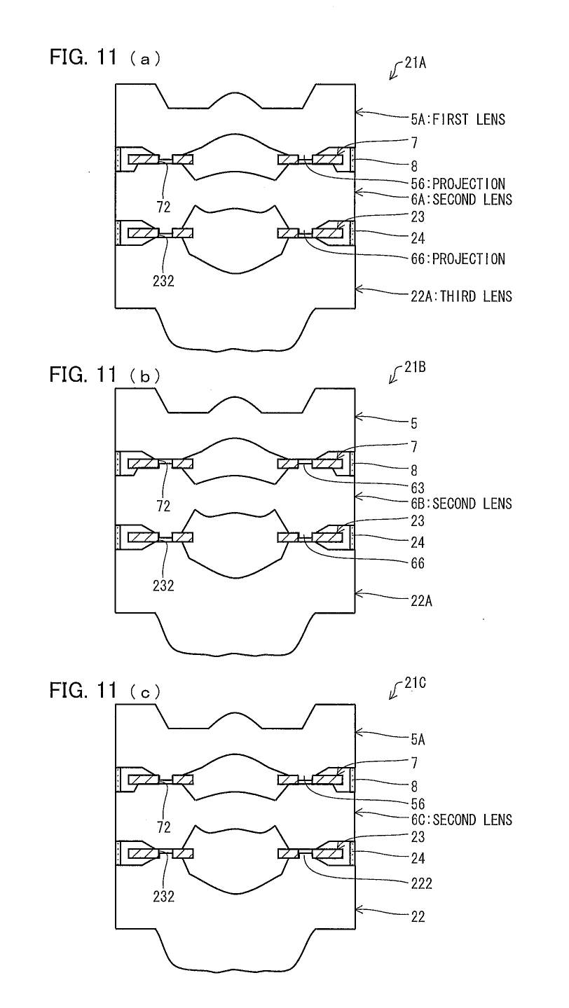

Another embodiment of the present invention is described below with reference to FIGS. 10 through 11(c).

In the present embodiment, those components having the same configurations as those of Embodiment 1 above are given the same reference signs, and as such, are not described.

(Configuration of an Image Pickup Element Module)

FIG. 10 is a longitudinal sectional view showing in detail a configuration of an image pickup element module 11 according to the present embodiment. FIGS. 11(a) to 11(c) are cross-sectional views of structures of other lens units 21A to 21C, respectively, each of which is used in the image pickup element module 11 of FIG. 10.

As with the image pickup element module 1 described above, the image pickup element module 11 according to the present embodiment includes a light blocking holder 2 and an image pickup element unit 3. Instead of including the lens unit 4, the image pickup element module 11 according to the present embodiment includes a lens unit 21.

<Configuration of the Lens Unit>

As with the lens unit 4, the lens unit 21 has a first lens 5, a second lens 6, and a light blocking plate 7, with the first lens 5 and the second lens 6 joined with an adhesive 8. Further, the lens unit 21 further includes a third lens 22 (lens) and a light blocking plate 23. The second lens 6 and the third lens 22 are joined together by being bonded to each other with an adhesive 24 at their peripheral edge surfaces facing each other.

The light blocking plate 23 has a passage 231 and fixing holes 232 (insertion holes). The passage 231 is equivalent to the passage 71 of the light blocking plate 7, and the fixing holes 232 are equivalent to the fixing holes 72 of the light blocking plate 7. The third lens 22 has a spacer section 221 and projections 222 on the same side as the light incidence surface. The projections 222, formed on a flat surface provided at the top of the spacer section 221, are equivalent to the projections 63 from the second lens 6. The light blocking plate 23 is retained by the third lens 22 by the projections 222 being inserted into the fixing holes 232 provided in the light blocking plate 23. In this state, the tips of the projections 222 do not make contact with the second lens 6.

The lens unit 21 is applied to a configuration in which the light blocking plate 23 has the fixing holes 232, but is not limited to such a configuration. For example, the lens unit 21 may be applied to a configuration in which instead of having the fixing holes 232, the light blocking plate 23 has notches equivalent to the aforementioned notches 74 or 76.

<Configurations of the Other Lens Units>

The lens unit 21 may be configured as any one of the other lens units 21A to 21C as shown in FIGS. 11(a) to 11(c).

As shown in FIG. 11(a), the lens unit 21A has the aforementioned first lens 5A (FIG. 9(a)), a second lens 6A, and a third lens 22A. Instead of having projections 63, the second lens 6A has projections 66 formed on the spacer section 65. Further, the third lens 22A does not have the projections 222. The projections 56 from the first lens 5A are inserted into the fixing holes 72 in the light blocking plate 7. Further, the projections 66 from the second lens 6A are inserted into the fixing holes 232 in the light blocking plate 23.

As shown in FIG. 11(b), the lens unit 21B has a first lens 5, a second lens 6B, and a third lens 22A. The second lens 6B has projections 63 on the light incidence side and projections 66 on the light exit side.

As shown in FIG. 11(c), the lens unit 21C has a first lens 5A, a second lens 6C, and a third lens 22. The second lens 6C does not have any projections 63 or 66.

As for the first lens 5, the second lens 6, and the third lens 22, the configurations of the lens units 4A and 4B can be applied to the aforementioned lens units 21 and 21A to 21C.

<Fabrication of the Lens Unit>

The lens unit 21 (21A to 21C) thus configured is also fabricated in the same manner as the aforementioned lens unit 4. Specifically, the lens unit 21 is completed by executing the adhesive application step of applying the adhesive 24 to the third lens 22, executing the bonding step of bonding the second lens 6 to the third lens 22, and then executing the adhesive application step, the bonding step, and the cutting step as shown in FIGS. 8(a) to 8(c).

### General Overview of the Embodiment

As described above, in an image pickup element module 11 according to the present embodiment, projections 56 or 63 are inserted into fixing holes 72, and projections 66 or 222 are inserted into fixing holes 232. This causes a light blocking plate 7 to be retained by a first lens 5A or a second lens 6 or 6B, and causes a light blocking plate 23 to be retained by the second lens 6B or a third lens 22.

As in the case of the aforementioned image pickup element module 1, this makes it possible to prevent the light blocking plate 7 from being displaced with respect to the first lens 5 and the second lens 6 due to vibration or impact and prevent the light blocking plate 23 from being displaced with respect to the second lens 6 and the third lens 22 due to vibration or impact. Therefore, the optical characteristics of the lens unit 21 can be kept satisfactory. Further, since it is not necessary to fix the light blocking plates 7 and 23 with the adhesives 8 and 24, respectively, the adhesive 8 needs only be used in such a minimum amount as to bond the first lens 5 and the second lens 6 together, and the adhesive 24 needs only be used in such a minimum amount as to bond the second lens 6 and the third lens 22 together. This makes it possible to suppress an increase in the cost of fabricating the lens unit 21.

Further, use of the three lenses allows various combinations of arrangements of projections, so that desired projections can be provided on the lenses according to fabricating conditions and the like.

The present embodiment adopts a structure in which the projections 56 or 63 are inserted into the fixing holes 72 and the projections 66 or 222 are inserted into the fixing holes 232. However, the present embodiment is not limited to such a structure, but the light blocking plate 7 needs only have a structure for retaining the projections 56 or 63, and the light blocking plate 23 has a structure for retaining the projections 66 or 222.

### Embodiment 3

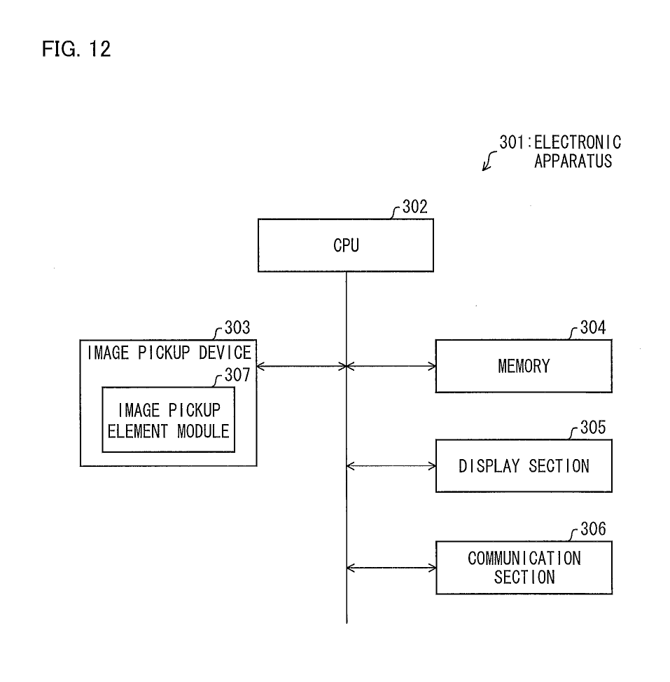

Still another embodiment of the present invention is described below with reference to FIG. 12.

In the present embodiment, those components having the same configurations as those of Embodiments 1 and 2 above are given the same reference signs, and as such, are not described.

(Electronic Information Apparatus)

FIG. 12 is a block diagram schematically showing a configuration of an electronic apparatus 301 according to the present embodiment.

As shown in FIG. 12, the electronic apparatus 301 includes a CPU 302, an image pickup device 303, a memory 304, a display section 305, and a communication section 306.

The CPU 302 controls the image pickup operation of the image pickup device 303 and writes image data outputted from the image pickup device 303 to the memory 304 or causes the display section 305 to display such image data. Further, the CPU 302 controls the communication section 306, thereby sending image data read out from the memory 304 to an external device or writing image data received from an external device to the memory 304.

The image pickup device 303, which has an image pickup element module 307, generates image data by performing a predetermined process on an image pickup signal from the image pickup element module 307. As the image pickup element module 307, the aforementioned image pickup element module 1 or 11 is used.

The memory 304, provided so as to stored image data, may be a memory device fixedly provided inside of the electronic apparatus 301 or a recording medium detachably provided in the electronic apparatus 301.

The display section 305, provided so as to display image data, is constituted by a liquid crystal display device and the like.

The communication section 306, provided so as to perform communication with an external device, performs cable communication via a USB cable or the like or wireless communication compatible with a wireless LAN or the like.

Examples of the electronic apparatus 301 include a camera apparatus and an apparatus having a camera (image pickup) function. Examples of the camera apparatus include digital cameras such as digital video cameras and digital still cameras. The camera apparatus may be a monitoring camera such as a surveillance camera, an intercom camera, an in-car camera (such as a tail surveillance camera), or a camera for television-phone use. Meanwhile, the apparatus having a camera (image pickup) function is a scanner apparatus, a facsimile apparatus, a television-phone apparatus, a camera-equipped cellular phone apparatus, a portable terminal apparatus (PDA), or the like.

The electronic apparatus 301 is mounted with an image pickup element module 1 or 11 as the image pickup element module 307. The image pickup element module 1 or 11 can be fabricated at low cost and has satisfactory optical characteristics. This makes it possible to easily reduce the cost of and enhance the performance of the electronic apparatus 301.

[Additional Matters]

The present embodiment can also be expressed as follows:

An optical apparatus as a lens device is constituted by at least two lenses and a light blocking plate, and includes a lens unit having the light blocking plate between the lenses, with the lenses having projections for fixing the light blocking plate and with the light blocking plate having holes or notches corresponding to the projections from the lenses.

It is preferable that the lenses between which the light blocking plate is sandwiched be in contact via the light blocking plate.

It is preferable that the two lenses be fixed with an adhesive.

The optical apparatus preferably has a clearance between a body tube and the lenses or between the body tube and the light blocking plate.

It is preferable that the lenses be lenses made of resin.

It is preferable that the projections from one of the lenses be of such a height as not to make contact with the other lens.

It is preferable that each lens have at least two projections therefrom.

It is preferable that the projections be provided on both or either of the lenses in contact with the light blocking plate.

Alternatively, the present invention can also be expressed as follows:

The lens device is preferably configured such that the retention structure is insertion holes into which the projections are inserted. Alternatively, the lens device is preferably configured such that the retention structure is notches in which the projections are fitted. Since the retention structure is insertion holes or notches, the retention structure can be easily formed in the light blocking plate.

The lens device is preferably configured such that the projections are of such a size as not to make contact with that one of the lenses which faces the lens on which the projections are provided. This prevents the projections from making contact with the lens they face even when they become larger due to thermal expansion. This makes it possible to avoid such inconvenience that the projections knock up the lens they face due to thermal expansion.

The lens device is preferably configured such that the projections are provided on either of those two of the lenses which are in contact with the light blocking plate. This makes it unnecessary for the other lens to have any projections and accordingly makes it unnecessary to use a special die for fabricating the other lens. Therefore, the fabricating cost can be curbed.

The lens device is preferably configured such that the projections are provided on both of those two of the lenses which are in contact with the light blocking plate. With this, the stress that retains the light blocking plate is dispersed across the projections from both of the lenses, the burden on the projections is reduced. This makes the projections hard to break.

The lens device is preferably configured such that those two of the lenses which face each other are bonded to each other with an adhesive. This makes it only necessary to use so much adhesive to bond the lenses together and eliminates the use of an adhesive to fix the light blocking plate to the lenses.

The lens device is preferably configured to further include an image pickup element unit that takes an image via the lens unit. This allows the lens device to function as an image pickup device.

### INDUSTRIAL APPLICABILITY

The present invention can be suitably applied to a camera apparatus having an image pickup element module including a lens unit having a plurality of lenses and a light blocking plate and to an apparatus having a camera function.

### REFERENCE SIGNS LIST

1 Image pickup module (lens device)
2 Light blocking holder (body tube)
3 Image pickup element unit
4 Lens unit
5 First lens (lens)
5A First lens (lens)
5B First lens (lens)
6 Second lens (lens)
6A Second lens (lens)
6B Second lens (lens)
6C Second lens (lens)
7 Light blocking plate
7A Light blocking plate
7B Light blocking plate
7C Light blocking plate
7D Light blocking plate
7E Light blocking plate
8 Adhesive
11 Image pickup element module (lens device)
21 Lens unit
21A Lens unit
21B Lens unit
21C Lens unit
22 Third lens
22A Third lens
23 Light blocking plate
24 Adhesive
56 Projection
57 Projection
63 Projection
66 Projection
72 Fixing hole (insertion hole, retention structure)
74 Notch (retention structure)
76 Notch (retention structure)
77 Fixing hole (insertion hole, retention structure)
222 Projection
232 Fixing hole (insertion hole, retention structure)
301 Electronic apparatus
307 Image pickup element module
d Clearance

1. A lens device comprising:
a lens unit having two or more lenses made of resin and bonded to each other and a light blocking plate placed between each of the lenses and the other; and
a body tube in which the lens unit is placed, with a clearance provided between the lens unit and the body tube,
at least one of the lenses having at least two projections,
the light blocking plate having a retention structure for retaining the projections.

2. The lens device as set forth in claim 1, wherein the retention structure is insertion holes into which the projections are inserted.

3. The lens device as set forth in claim 1, wherein the retention structure is notches in which the projections are fitted.

4. The lens device as set forth in claim 2, wherein the projections are of such a size as not to make contact with that one of the lenses which faces the lens on which the projections are provided.

5. The lens device as set forth in claim 1, wherein the projections are provided on either of those two of the lenses which are in contact with the light blocking plate.

6. The lens device as set forth in claim 1, wherein the projections are provided on both of those two of the lenses which are in contact with the light blocking plate.

7. The lens device as set forth in claim 1, wherein those two of the lenses which face each other are bonded to each other with an adhesive.

8. The lens device as set forth in claim 1, further comprising an image pickup element unit that takes an image via the lens unit.

9. An electronic apparatus mounted with a lens device as set forth in claim 8.
